(19) United States
(12) Patent Application Publication
(10) Pub. No.: US 2013/0317822 A1
(43) Pub. Date: Nov. 28, 2013

(54) MODEL ADAPTATION DEVICE, MODEL ADAPTATION METHOD, AND PROGRAM FOR MODEL ADAPTATION

(71) Applicant: Takafumi Koshinaka, Tokyo (JP)

(72) Inventor: Takafumi Koshinaka, Tokyo (JP)

(21) Appl. No.: 13/982,481

(22) PCT Filed: Jan. 31, 2012
(86) PCT No.: PCT/JP2012/000606

§ 371 Date: Jul. 29, 2013

(30) Foreign Application Priority Data
Feb. 3, 2011 (JP) 2011-021918

(51) Int. Cl. G10L 15/065

(52) U.S. Cl. CPC G10L 15/065
USPC 704/244

(57) ABSTRACT

A model adaptation device includes a recognition unit which creates a recognition result of recognizing data that complies with a target domain which is an assumed condition of recognition target data, based on at least two models and a candidate of a weighting factor indicating a weight of each model on a recognition process. A weighting factor determination unit determines the weighting factor so as to assign a smaller weight to a model having higher reliability. A model update unit updates at least one model out of the models, using the recognition result as the truth label.

### TECHNICAL FIELD

The present invention relates to a model adaptation device, a model adaptation method, and a program for model adaptation that perform model adaptation using data not assigned a truth label, namely, unsupervised adaptation.

### BACKGROUND ART

A method of improving unsupervised adaptation of an acoustic model and a language model is described in Non Patent Literature (NPL) 1. In the method described in NPL 1, MLLR (Maximum Likelihood Linear Regression) is used as unsupervised adaptation of the acoustic model. Moreover, the language model is constructed by building an adaptive model by linear interpolating word N-gram and class N-gram as a baseline.

As one of various computation methods, a computation method based on dynamic programming is described in NPL 2. In addition, iterative solution methods by steepest gradient algorithms are described in Patent Literature (PTL) 1 and NPL 3.

### CITATION LIST

### Patent Literature(s)

PTL 1: Domestic re-publication of PCT international application WO2008/105263.

### Non Patent Literature(s)

NPL 1: Kusama, Okuyama, Katoh, Kosaka, “Improvement of unsupervised adaptation in lecture speech recognition,” IEICE Technical Report (SP), Jun. 28, 2007, Vol. 107, No. 116, SP2007-20, pp. 73-78.

NPL 2: F. Wessel, R. Schluter, K. Macherey, H. Ney, “Confidence measures for large vocabulary continuous speech recognition,” IEEE Transactions on Speech and Audio Processing, Vol. 9, No. 3, pp. 288-298, March 2001.

NPL 3: T. Emori, Y. Onishi, K. Shinoda, “Automatic Estimation of Scaling Factors Among Probabilistic Models in Speech Recognition,” Proc. of INTERSPEECH2007, pp. 1453-1456, 2007.

### SUMMARY OF INVENTION

### Technical Problem

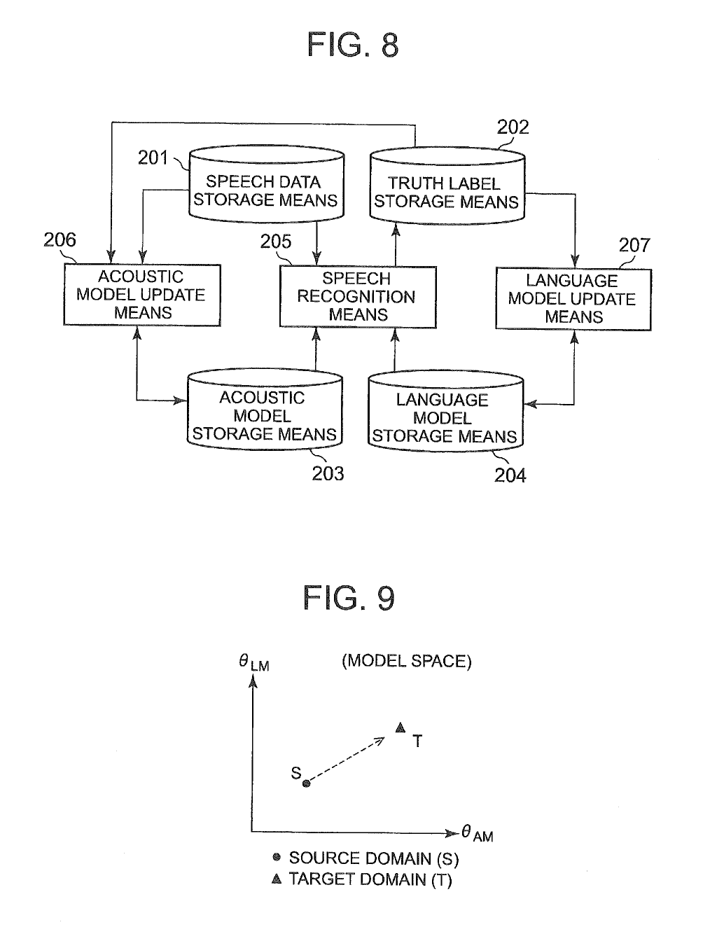

FIG. 8 is a block diagram showing an example of a typical model adaptation device that adapts models used in speech recognition, based on the method described in NPL 1.

The model adaptation device illustrated in FIG. 8 includes speech data storage means 201, truth label storage means 202, acoustic model storage means 203, language model storage means 204, speech recognition means 205, acoustic model update means 206, and language model update means 207.

The speech data storage means 201 stores speech data. The acoustic model storage means 203 stores an acoustic model. The language model storage means 204 stores a language model. The speech recognition means 205, having read the speech data stored in the speech data storage means 201, performs speech recognition by referencing to each of the acoustic model stored in the acoustic model storage means 203 and the language model stored in the language model storage means 204, and writes the speech recognition result to the truth label storage means 202.

The acoustic model update means 206 reads the acoustic model from the acoustic model storage means 203, and also reads the speech data stored in the speech data storage means 201 and the recognition result (i.e. truth label) stored in the truth label storage means 202. The acoustic model update means 206 adapts the acoustic model so as to meet the acoustic condition of the speech data, and stores the adapted acoustic model in the acoustic model storage means 203.

The language model update means 207 reads the language model from the language model storage means 204, and also reads the recognition result (i.e. truth label) stored in the truth label storage means 202. The language model update means 207 adapts the language model so as to meet the language condition of the recognition result, and stores the adapted language model in the language model storage means 204. Note that the series of processes including the speech recognition, the acoustic model update, and the language model update may be iteratively executed in arbitrary order an arbitrary number of times.

The above describes the case where the above-mentioned model adaptation device is used for the method of adapting the acoustic model and the language model used in speech recognition, as an example. Such a model adaptation technique for adapting a model may be used not only in speech recognition but also in various types of pattern recognition. For instance, the model adaptation technique is applicable to adaptation of a character image model and a language model in an optical character reader (OCR), a video event model and an event language model in a video event detector used for a gesture recognition system, and the like.

However, in the case where the speech recognition result contains many errors when performing speech recognition using the above-mentioned typical model adaptation device, there is a problem that the acoustic model and the language model necessary for achieving high recognition accuracy cannot be created in the acoustic model update process and the language model update process. This is because, when the model is adapted using the truth label containing noise as the erroneous recognition result, the resulting model does not sufficiently meet the object speech data.

Model adaptation is a procedure of converting, in the case where each type of condition (hereafter such a condition is referred to as a domain) such as the assumed acoustic condition and language condition is different from the domain of the recognition target data, the model of the original domain (hereafter referred to as a source domain) so as to meet the domain of the recognition target (hereafter referred to as a target domain).

FIG. 9 is an explanatory diagram conceptually showing the conversion procedure by model adaptation. When a set of parameters defining the acoustic model is denoted by θ_{AM} and a set of parameters defining the language model is denoted by θ_{LM}, the model of the source domain S corresponds to a point S on a model space defined by θ_{AM} and θ_{LM}. Here, in the case where a point T on the model space corresponds to the model of the target domain T, model adaptation can be regarded as a procedure of moving the pair of the acoustic model and the language model from the point S to the point T.

This is described below, using a simple example. Suppose the source domain S is “acoustic condition=quiet environment, language condition=topic of politics,” and the target domain T is “acoustic condition=loud environment, language condition=topic of sports.” In this case, the acoustic model and the language model of the source domain S are models assuming to recognize speech about a topic of politics in a situation of being spoken in a quiet environment.

In the case where the recognition target is a topic of sports spoken in a loud environment, however, there is a domain mismatch between the recognition target and the model of the source domain S. It is therefore inappropriate to use the source domain S for such target. Accurate speech recognition is impossible in the case where the source domain S is used. Hence, model adaptation is a process of converting the model from S to T in order to eliminate the mismatch and enable accurate speech recognition.

Note that the acoustic condition includes not only noise exemplified above but also a condition regarding a speaker, line quality in speech transmission, and the like. The language condition includes not only a topic exemplified above but also a condition regarding a speaker, line quality in speech transmission, and the like, and includes not only a topic but also a condition regarding vocabulary, a manner of speaking (literal, colloquial), and the like. These various conditions can be served as elements defining a domain.

Thus, in model adaptation, there is the premise that the source domain and the target domain are different. That is, adaptation is necessary in the case where there is a mismatch between the source domain and the target domain, though adaptation is not necessary if there is no mismatch between the source domain and the target domain. As long as there is a mismatch, there is a possibility that noise representing recognition errors is contained in the truth label necessary for model adaptation. Especially in the case where the source domain and the target domain are significantly different, many recognition errors are contained in the truth label. This makes it difficult to obtain a favorable model by adaptation.

In view of this, the present invention has an exemplary object of providing a model adaptation device, a model adaptation method, and a program for model adaptation that can create a favorable model from the data of the target domain even in the case where there is a difference between the original domain and the target domain and a lot of noise representing recognition errors is contained in the truth label created based on the original domain.

### Solution to Problem

A model adaptation device according to an exemplary aspect of the present invention includes: recognition means for creating a recognition result of recognizing data that complies with a target domain which is an assumed condition of recognition target data, based on at least two models and a candidate of a weighting factor indicating a weight of each model on a recognition process; model update means for updating at least one model out of the models, using the recognition result as a truth label; and weighting factor determination means for determining the weighting factor, wherein the weighting factor determination means determines the weighting factor so as to assign a smaller weight to a model having higher reliability, wherein the recognition means creates the recognition result based on the weighting factor determined by the weighting factor determination means, and wherein the model update means updates the model, using the recognition result created based on the weighting factor as the truth label.

A model adaptation method according to an exemplary aspect of the present invention includes: creating a recognition result of recognizing data that complies with a target domain which is an assumed condition of recognition target data, based on at least two models and a candidate of a weighting factor indicating a weight of each model on a recognition process; determining the weighting factor so as to assign a smaller weight to a model having higher reliability; creating the recognition result based on the determined weighting factor; and updating at least one model out of the models, using the recognition result as the truth label.

A program for model adaptation according to an exemplary aspect of the present invention causes a computer to execute: a recognition process of creating a recognition result of recognizing data that complies with a target domain which is an assumed condition of recognition target data, based on at least two models and a candidate of a weighting factor indicating a weight of each model on a recognition process; a model update process of updating at least one model out of the models, using the recognition result as a truth label; and a weighting factor determination process of determining the weighting factor, wherein the weighting factor is determined so as to assign a smaller weight to a model having higher reliability, in the weighting factor determination process, wherein the recognition result is created based on the weighting factor determined in the weighting factor determination process, in the recognition process, and wherein the model is updated using the recognition result created based on the weighting factor as the truth label, in the model update process.

### Advantageous Effects of Invention

According to the present invention, a favorable model can be created from the data of the target domain even in the case where there is a difference between the original domain and the target domain and a lot of noise representing recognition errors is contained in the truth label created based on the original domain.

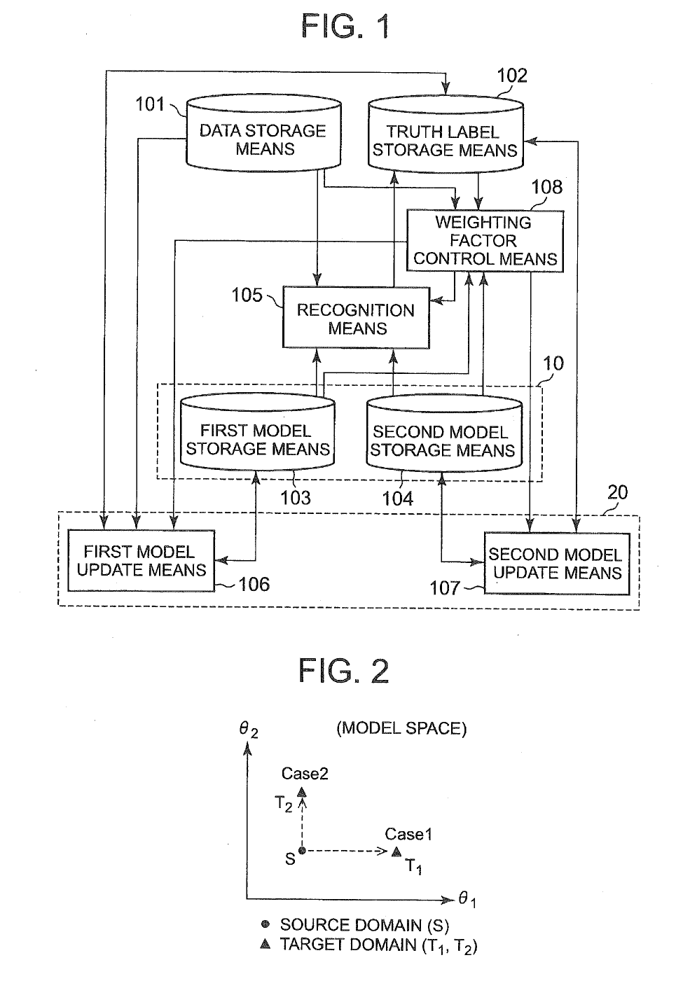

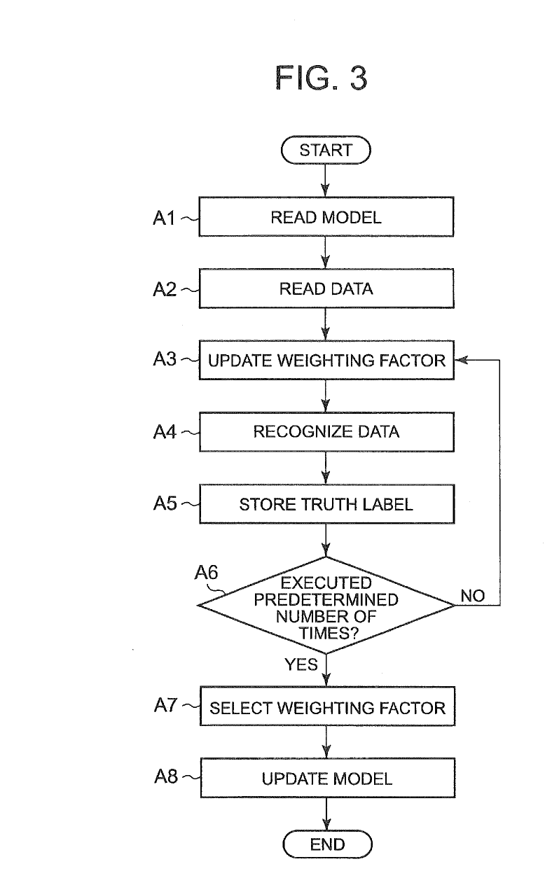

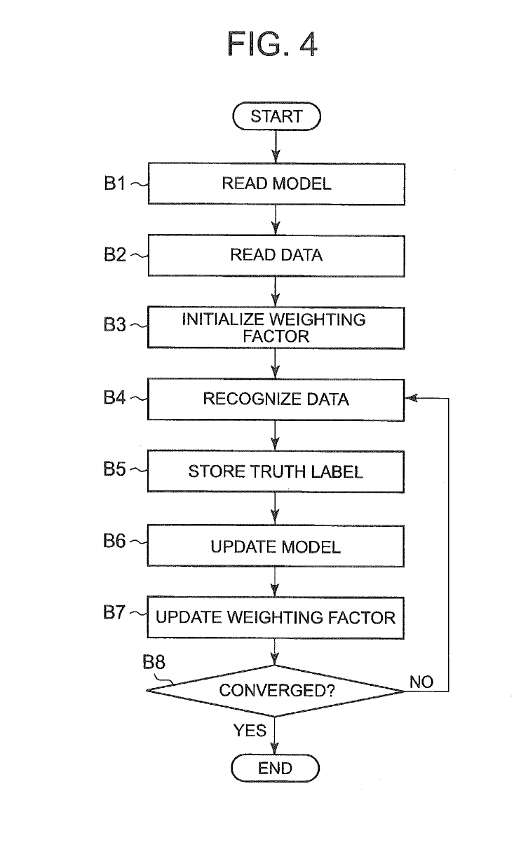

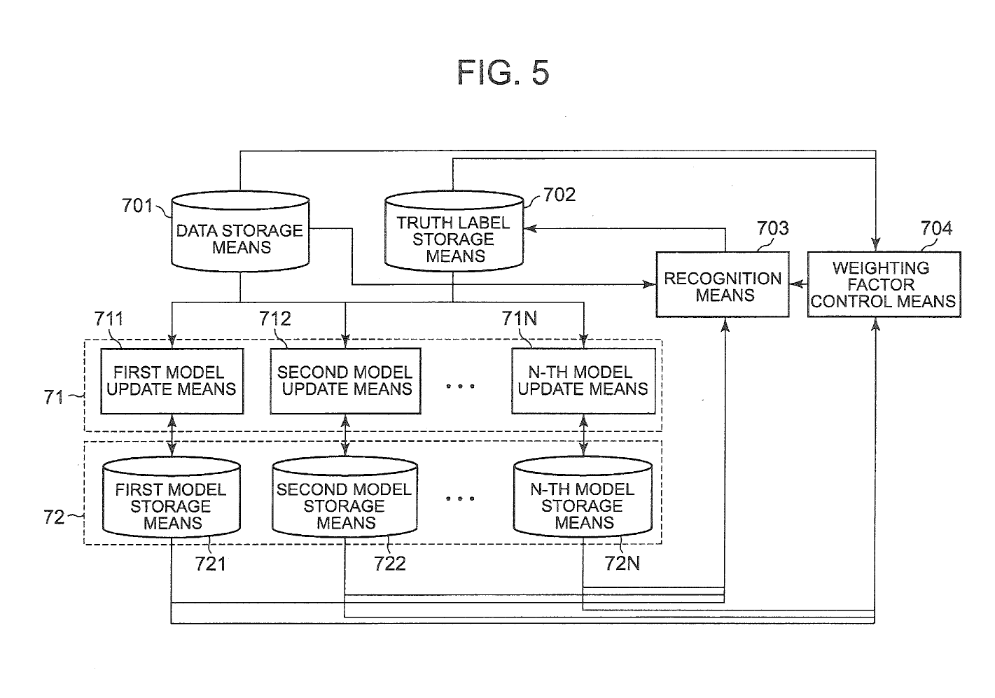

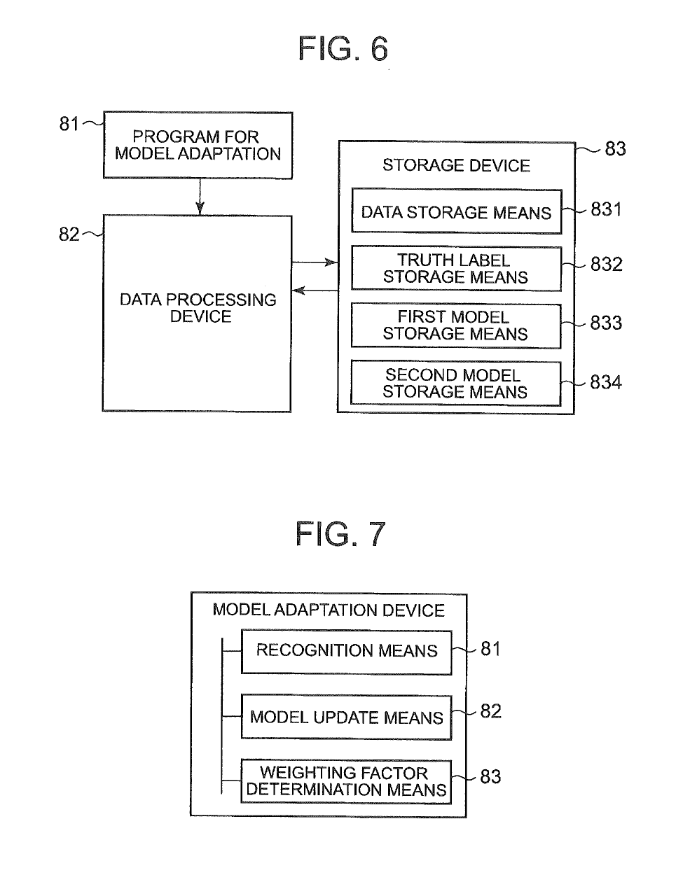

### BRIEF DESCRIPTION OF DRAWINGS

[FIG. 1] It depicts a block diagram showing an example of a model adaptation device in Exemplary Embodiment 1 of the present invention.

[FIG. 2] It depicts an explanatory diagram showing an example of a method of determining a weighting factor.

[FIG. 3] It depicts a flowchart showing an operation example of the model adaptation device in Exemplary Embodiment 1.

[FIG. 4] It depicts a flowchart showing an operation example of a model adaptation device in Exemplary Embodiment 2.

[FIG. 5] It depicts a block diagram showing an example of a model adaptation device in Exemplary Embodiment 3 of the present invention.

[FIG. 6] It depicts a block diagram showing an example of a computer for realizing a model adaptation device according to the present invention.

[FIG. 7] It depicts a block diagram showing an example of a minimum structure of a model adaptation device according to the present invention.

[FIG. 8] It depicts a block diagram showing an example of a typical model adaptation device.

[FIG. 9] It depicts an explanatory diagram conceptually showing a conversion procedure by model adaptation.

### DESCRIPTION OF EMBODIMENT(S)

The following describes exemplary embodiments of the present invention with reference to drawings.

### Exemplary Embodiment 1

FIG. 1 is a block diagram showing an example of a model adaptation device in Exemplary Embodiment 1 of the present invention. The model adaptation device in this exemplary embodiment includes data storage means 101, truth label storage means 102, model storage means 10, recognition means 105, model update means 20, and weighting factor control means 108. The model storage means 10 includes first model storage means 103 and second model storage means 104. The model update means 20 includes first model update means 106 and second model update means 107.

The data storage means 101 stores data of a target domain. As mentioned earlier, the target domain is the assumed condition of the recognition target data, and the data of the target domain means data that complies with the condition indicated by the target domain. For example, the data of the target domain is stored in the data storage means 101 beforehand by a user or the like.

The truth label storage means 102 stores the recognition result output from the below-mentioned recognition means 105, as a truth label.

The first model storage means 103 stores a first model used when recognizing the data. Likewise, the second model storage means 104 stores a second model used when recognizing the data. The first model and the second model are stored respectively in the first model storage means 103 and the second model storage means 104 by the user or the like as an initial state.

The recognition means 105, upon receiving a weighting factor from the below-mentioned weighting factor control means 108, reads the first model and the second model stored respectively in the first model storage means 103 and the second model storage means 104. The recognition means 105 recognizes the data stored in the data storage means 101, based on these read models and the weighting factor candidate. The weighting factor mentioned here means the weight of each model on the recognition process.

Note that, in the case where the contents of the already read models can be used such as when there is no change in the contents of the models, the recognition means 105 does not need to read the first model and the second model from the first model storage means 103 and the second model storage means 104. The recognition means 105 then stores the recognition result in the truth label storage means 102 as the truth label.

For example, in the case where the recognition target data is speech, the first model can be associated with an acoustic model, and the second model can be associated with a language model. The acoustic model is a standard sound pattern for each phoneme, and the language model is data obtained by quantifying connectivity between words. In this case, the recognition means 105 compares the input speech with various phoneme patterns and also takes the word connectivity into account, to obtain a character string or a word string that best matches the input speech. The recognition means 105 recognizes the recognition target data in this way.

For example, the recognition means 105 may evaluate a probability P(W|O) that the recognition result of given data O is W using the following Expression 1 based on Bayes' theorem, and set W corresponding to maximum P(W|O) as the top recognition result. Note that the method of recognizing the data by the recognition means 105 is not limited to the method using Expression 1.

[Math. 1]

log P(W|O)=log P(O|W,θ₁)+κ log P(W|θ₂)+const (Expression 1)

Here, κ is the weighting factor received from the below-mentioned weighting factor control means 108. The first term in the right side corresponds to an evaluation expression based on the first model, and the second term in the right side corresponds to an evaluation expression based on the second model. The factor κ of the second term is the weighting factor by which the second model is multiplied. θ₁ is a set of parameters defining the first model, and θ₂ is a set of parameters defining the second model. Here, the weighting factor by which the first model is multiplied is 1 which is a constant. For instance, in the case where the data is speech, the first term corresponds to the acoustic model and the second term corresponds to the language model. Note that the recognition target data is not limited to speech. In the case where the data is other than speech, too, the recognition means 105 can recognize the data using the above Expression 1.

It is desirable that the recognition means 105 creates the recognition result that includes not only the result of the top likelihood but an N-best list of the top to N-th candidates. It is also desirable that, in the case where the data is time-series data such as speech, a video, or a character string, the recognition means 105 creates the recognition result in the form of a lattice (graph) or the like by connecting the recognition result candidates corresponding to different times by a network.

The weighting factor control means 108 controls the weighting factor by which the first model and the second model are multiplied, when the recognition means 105 recognizes the data of the target domain. In detail, the weighting factor control means 108 sequentially notifies the recognition means 105 of predetermined values as candidates of the weighting factor by which the first model and the second model are multiplied, to operate the recognition means 105.

The weighting factor control means 108 also determines an optimal value from among the candidates of the weighting factor by which the first model and the second model are multiplied, by referencing to the recognition result stored in the truth label storage means 102, the data stored in the data storage means 101, the first model stored in the first model storage means 103, and the second model stored in the second model storage means 104.

Note that, in the case where there is no change in the contents of the already referenced first model and second model, the weighting factor control means 108 may determine the optimal weighting factor using the contents of the already referenced models.

FIG. 2 is an explanatory diagram showing an example of the method of determining the weighting factor. S denotes the source domain, and T₁ and T₂ denote the target domain. The weighting factor determination method is described below, with reference to FIG. 2. As mentioned earlier, model adaptation is regarded as conversion from one point (source domain) to another point (target domain) on a space (model space) defined by parameters of two models.

All kinds of patterns are conceivable for the relationship between the source domain and the target domain. As one basic pattern, there is a case where only the domains of the first model are different and the domains of the second model are substantially the same, as in the relationship between S and T₁ illustrated in FIG. 2. As another basic pattern, there is a case where only the domains of the second model are different and the domains of the first model are substantially the same, as in the relationship between S and T₂ illustrated in FIG. 2.

In these basic patterns, the weighting factor can be set in the following manner. In the case where the domains of the second model are the same as in the relationship between S and T₁, the second model is reliable upon recognizing the data of the target domain. Accordingly, a larger weight is assigned to the second model and a smaller weight is assigned to the first model. On the other hand, in the case where the domains of the first model are the same as in the relationship between S and T₂, the first model is reliable. Accordingly, a larger weight is assigned to the first model and a smaller weight is assigned to the second model.

The above consideration is generalized as follows. The weighting factor is determined according to the gap between the source domain and the target domain in the first model and the gap between the source domain and the target domain in the second model. In detail, the weight of the model having a larger gap between the domains needs to be smaller.

The weighting factor control means 108 may use any method that can set the weighting factor of the model having a larger gap between the domains to be smaller (in other words, set the weighting factor of the model having a smaller gap between the domains to be larger), as the weighting factor determination method. As an example, the weighting factor control means 108 may determine the weighting factor so as to maximize the conditional probability P(W|O) of the recognition result W when the data O of the target domain is given.

For example, in the case where the recognition means 105 performs data recognition using the above Expression 1, the weighting factor control means 108 determines the weighting factor so as to maximize the conditional probability of the recognition result for the data of the target domain. In detail, the weighting factor control means 108 selects an optimal value from the weighting factor candidates K₁, K₂, . . . so as to maximize an objective function exemplified in the following Expression 2.

[Math. 2]

P_{κ}(W^{(κ)}|O)∝exp└log P(O|W^{(κ)},θ₁)+κ log P(W^{(κ)}|θ₂)┘ (Expression 2)

Here, W^{κ} is the recognition result created by the recognition means 105 based on the weighting factor κ. The method of determining the weighting factor candidates is arbitrary. For example, the values obtained by dividing the range from 0.1 to 10 into ten equal parts on an appropriate scale such as an exponential scale or a logarithmic scale may be determined as the weighting factor candidates. In the case where the recognition result is a large-scale lattice (graph) connecting many recognition result candidates by a network, a large amount of computation is required for computing P(O|W^{(κ), θ}₁) and P(W^{(κ)}|θ₂) in the right side of the above Expression 2. In such a case, the weighting factor control means 108 can efficiently determine the weighting factor by, for example, performing the computation based on dynamic programming described in NPL 2.

The first model update means 106 adapts the first model using the data stored in the data storage means 101 and the truth label stored in the truth label storage means 102. Likewise, the second model update means 107 adapts the second model using the data stored in the data storage means 101 and the truth label stored in the truth label storage means 102.

In detail, the first model update means 106 adapts the first model to the target domain, based on the recognition result (i.e. truth label) output from the recognition means 105 and stored in the truth label storage means 102. Here, the first model update means 106 uses W^{(κ)} (i.e. the recognition result created by the recognition means 105 based on the weighting factor κ) corresponding to the weighting factor κ selected by the weighting factor control means 108, as the truth label.

The first model update means 106 may also use the data stored in the data storage means 101, according to need (in detail, when necessary for the adaptation process). For example, in the case where the recognition target data is speech, the truth label and the speech data are necessary when adapting the acoustic model, and so the first model update means 106 uses the speech data stored in the data storage means 101. On the other hand, the speech data is unnecessary when adapting the language model, and so the first model update means 106 does not use the speech data stored in the data storage means 101.

The first model update means 106 updates the first model using the model obtained as a result of adaptation, and stores the updated first model in the first model storage means 103.

As an example, in the case where the model to be adapted is the acoustic model, the first model update means 106 may perform model adaptation by MLLR. As another example, in the case where the model to be adapted is the language model, the first model update means 106 may build an adaptive model by linear interpolating word N-gram and class N-gram created from a large amount of text, as in the language model adaptation method described in NPL 1. Note that the model to be adapted is not limited to the acoustic model and the language model, and also the adaptation method is not limited to the above-mentioned method.

The second model update means 107 adapts the second model to the target domain based on the recognition result (i.e. truth label) output from the recognition means 105 and stored in the truth label storage means 102, in the same way as the first model update means 106. Here, the second model update means 107 equally uses W^{(κ)} (i.e. the recognition result created by the recognition means 105 based on the weighting factor κ) corresponding to the weighting factor κ selected by the weighting factor control means 108, as the truth label. The model adaptation method used here may be the same as or different from the model adaptation method of the first model update means 106.

The second model update means 107 may also use the data stored in the data storage means 101 according to need. The second model update means 107 updates the second model using the model obtained as a result of adaptation, and stores the updated second model in the second model storage means 104.

Note that either one or both of the first model update means 106 and the second model update means 107 may perform model update.

For example, the data storage means 101, the truth label storage means 102, and the model storage means 10 (more specifically, the first model storage means 103 and the second model storage means 104) are realized by a magnetic disk or the like.

The recognition means 105, the model update means 20 (more specifically, the first model update means 106 and the second model update means 107), and the weighting factor control means 108 are realized by a CPU of a computer operating according to a program (program for model adaptation). For example, the program may be stored in a storage unit (not shown) of the model adaptation device, with the CPU reading the program and, according to the program, operating as the recognition means 105, the model update means 20 (more specifically, the first model update means 106 and the second model update means 107), and the weighting factor control means 108.

Alternatively, the recognition means 105, the model update means 20 (more specifically, the first model update means 106 and the second model update means 107), and the weighting factor control means 108 may each be realized by dedicated hardware.

Though the above describes the case where the model adaptation device handles speech data, the data handled by the model adaptation device is not limited to speech data.

The model adaptation device in this exemplary embodiment is capable of handling arbitrary data such as speech, an image, and a video. In this case, the recognition means 105 may recognize the data by combining a plurality of models.

In detail, in the case where the recognition target data is speech, for example, the first model corresponds to an acoustic model of phonemes and the second model corresponds to a language model of words. In the case where the recognition target data is a character image, for example, the first model corresponds to a character image model and the second model corresponds to a language model of words. In the case where the recognition target data is a video representing gestures, for example, the first model corresponds to a video model of defined gestures and the second model corresponds to a language model (e.g. grammatical rule) specifying gesture appearance tendencies.

The following describes an operation of the model adaptation device in this exemplary embodiment. FIG. 3 is a flowchart showing an operation example of the model adaptation device in Exemplary Embodiment 1.

First, the recognition means 105 reads the first model from the first model storage means 103, and reads the second model from the second model storage means 104 (step A1). The recognition means 105 also reads the data stored in the data storage means 101 (step A2). The weighting factor control means 108 notifies the recognition means 105 of one weighting factor candidate (step A3).

The recognition means 105 recognizes the read data, by referencing to the first model, the second model, and the weighting factor candidate (step A4). The recognition means 105 stores the recognition result in the truth label storage means 102 as the truth label (step A5).

Note that the recognition means 105 may perform the processes of steps A2 and A4 by one operation. Moreover, in the case where the amount of data is relatively large, the recognition means 105 may employ pipeline processing of iteratively executing a process of reading and recognizing the data in a small unit. In such a case, it is preferable to perform the process of step A3 before step A2.

The recognition means 105 determines whether or not the process of steps A3 to A5 (i.e. the process of performing the recognition process using a different weighting factor candidate and storing the recognition result in the truth label storage means 102 as the truth label) has been executed a predetermined number of times (step A6). In the case where the process has not been executed the predetermined number of times (“NO” in step A6), the process from step A3 is repeated. In the case where the process has been executed the predetermined number of times, the operation proceeds to the process of step A7. Thus, the process of steps A3 to A5 is repeatedly performed while changing the weighting factor, the same number of times as the number of weighting factor candidates.

Next, the weighting factor control means 108 selects the optimal weighting factor according to, for example, the objective function of the above Expression 2, using the truth label stored in the truth label storage means 102 for each weighting factor candidate and the like (step A7).

The first model update means 106 adapts the first model to the target domain, based on the truth label corresponding to the optimal weighting factor. The first model update means 106 stores the updated first model obtained as a result of adaptation, in the first model storage means 103. Upon adaptation, the first model update means 106 may use the data stored in the data storage means 101 according to need.

Likewise, the second model update means 107 adapts the second model to the target domain, based on the truth label corresponding to the optimal weighting factor. The second model update means 107 stores the updated second model obtained as a result of adaptation, in the second model storage means 104. Upon adaptation, the second model update means 107 may use the data stored in the data storage means 101 according to need (step A8).

Note that the model adaptation device in this exemplary embodiment may repeatedly perform the series of processes in the flowchart illustrated in FIG. 3 a plurality of number of times. There is a possibility that recognizing the data again using the updated first model and second model enables a better recognition result (i.e. truth label) to be obtained. There is also a possibility that selecting the weighting factor again using the better truth label enables a better weighting factor suitable for the updated models to be obtained.

As described above, according to this exemplary embodiment, the recognition means 105 creates the truth label by recognizing the data of the target domain based on the first model, the second model, and the weighting factor candidate. The first model update means 106 updates the first model using the truth label, and the second model update means 107 updates the second model using the truth label. The weighting factor control means 108 controls the weighting factor when the recognition means 105 references to the first model and the second model.

In detail, the weighting factor control means 108 selects, from the weighting factor candidates, such a value that assigns a larger weight to a reliable model (i.e. a model having a smaller difference between the source domain and the target domain) among the first model and the second model. The recognition means 105 recognizes the data based on the weighting factor candidate, to create the truth label. The first model update means 106 and the second model update means 107 update the first model and the second model respectively, using the truth label created based on the weighting factor selected by the weighting factor control means 108.

According to the structure described above, a favorable model can be created from the data of the target domain, even in the case where there is a difference between the original domain (source domain) and the target domain and a lot of noise representing recognition errors is contained in the truth label created based on the original domain.

### Exemplary Embodiment 2

The following describes Exemplary Embodiment 2 of the present invention. A model adaptation device in this exemplary embodiment has the same structure as in Exemplary Embodiment 1 illustrated in FIG. 1. That is, the model adaptation device in Exemplary Embodiment 2 of the present invention includes the data storage means 101, the truth label storage means 102, the model storage means 10, the recognition means 105, the model update means 20, and the weighting factor control means 108. The model storage means 10 includes the first model storage means 103 and the second model storage means 104. The model update means 20 includes the first model update means 106 and the second model update means 107.

The data storage means 101 stores the data of the target domain. The first model storage means 103 and the second model storage means 104 respectively store the first model and the second model used when recognizing the data. The recognition means 105 recognizes the data by referencing to the first model and the second model. The truth label storage means 102 stores the recognition result output from the recognition means 105, as the truth label.

The first model update means 106 and the second model update means 107 respectively adapt the first model and the second model, using the data stored in the data storage means 101 and the truth label stored in the truth label storage means 102. The weighting factor control means 108 controls the weighting factor by which the first model and the second model are multiplied, when the recognition means 105 recognizes the data.

This exemplary embodiment differs from Exemplary Embodiment 1 in that, instead of selecting the optimal weighting factor from a predetermined finite number of candidates, the optimal value is searched for using a search algorithm.

The recognition means 105, upon receiving a weighting factor candidate from the weighting factor control means 108, reads the first model and the second model stored respectively in the first model storage means 103 and the second model storage means 104 according to need, and recognizes the data stored in the data storage means 101 based on these models and the weighting factor. The recognition means 105 then stores the recognition result (i.e. truth label) in the truth label storage means 102. Note that, in the case where an old truth label is already stored in the truth label storage means 102, the recognition means 105 writes the new truth label over the old truth label.

The method of recognizing the data by the recognition means 105 is the same as the method in Exemplary Embodiment 1. Moreover, it is desirable that the recognition result is the recognition result up to the N-th (N-best list) or in the form of a lattice (graph) or the like.

The weighting factor control means 108 determines the weighting factor for each model. In this exemplary embodiment, the weighting factor control means 108 first performs an initialization process of setting the weighting factor by which the first model and the second model are multiplied, to a predetermined initial value. After the initialization process, the weighting factor control means 108 sequentially updates the weighting factor, by referencing to the recognition result (i.e. truth label) output from the recognition means 105 and stored in the truth label storage means 102, the data stored in the data storage means 101, the first model stored in the first model storage means 103, and the second model stored in the second model storage means 104. The initial value set in the initialization process and each value to which the weighting factor is sequentially updated are each a value that can be the final weighting factor. Therefore, these values can also be regarded as weighting factor candidates.

Note that, in the case where there is no change in the contents of the already referenced first model and second model (e.g. in the case where the first model update means 106 and the second model update means 107 have not updated the respective models), the weighting factor control means 108 may update the weighting factor using the contents of the already reference models.

In the case where the recognition means 105 performs data recognition using the above Expression 1, the weighting factor control means 108 updates the weighting factor so as to maximize the conditional probability of the recognition result for the data of the target domain, as in Exemplary Embodiment 1. In detail, the weighting factor control means 108 updates the weighting factor so as to maximize the objective function exemplified in the above Expression 2.

As the method of updating the weighting factor, for example, the iterative solution method such as the steepest gradient algorithm described in NPL 3 or PTL 1 is available.

The weighting factor control means 108 may update the weighting factor κ using the following Expression 3, as an example.

$$\begin{matrix}[ Math . 3 ] & \\ κ ← κ + ρ \frac{d {P}_{κ} ( {W}^{( κ )} \vert O )}{d κ} & ( Expression 3 )\end{matrix}$$

Here, ρ is a predetermined constant indicating an update step size.

The weighting factor control means 108 then performs convergence determination of determining whether or not to repeat updating the weighting factor based on a predetermined condition. For example, the weighting factor control means 108 may determine whether or not the difference between the weighting factor before update and the weighting factor after update is greater than a predetermined threshold and, in the case where the difference is greater than the predetermined threshold, determine to update the weighting factor based on the recognition result by the recognition means 105. Alternatively, the weighting factor control means 108 may determine not to update the weighting factor, in the case where the weighting factor is updated a predetermined number of times. Note that the convergence determination method is not limited to these methods.

In the case where the weighting factor control means 108 determines to update the weighting factor, the recognition means 105 updates the truth label which is the recognition result, based on the models weighted by the updated weighting factor. The first model update means 106 and the second model update means 107 update the models based on the updated truth label, and the weighting factor control means 108 updates the weighting factor based on the updated models.

The first model update means 106 adapts the first model to the target domain, based on the latest recognition result (i.e. truth label) output from the recognition means 105 and stored in the truth label storage means 102. The first model update means 106 may use the data stored in the data storage means 101 according to need. The first model update means 106 updates the first model using the model obtained as a result of adaptation, and stores the updated first model in the first model storage means 103. The model adaptation method used here is the same as the model adaptation method of the first model update means 106 in Exemplary Embodiment 1.

The second model update means 107 adapts the second model to the target domain based on the recognition result (i.e. truth label) output from the recognition means 105 and stored in the truth label storage means 102, in the same way as the first model update means 106. The second model update means 107 may use the data stored in the data storage means 101 according to need. The second model update means 107 updates the second model using the model obtained as a result of adaptation, and stores the updated second model in the second model storage means 104. The model adaptation method used here may be the same as or different from the model adaptation method of the first model update means 106.

The model adaptation device in this exemplary embodiment is also capable of handling arbitrary data such as speech, an image, and a video. In this respect, too, the model adaptation device in this exemplary embodiment is the same as that in Exemplary Embodiment 1. The recognition means 105, the model update means 20, and the weighting factor control means 108 in this exemplary embodiment are realized by a CPU of a computer operating according to a program (program for model adaptation), too.

The following describes an operation of the model adaptation device in this exemplary embodiment. FIG. 4 is a flowchart showing an operation example of the model adaptation device in Exemplary Embodiment 2.

First, the recognition means 105 reads the first model from the first model storage means 103, and reads the second model from the second model storage means 104 (step B1). The recognition means 105 also reads the data stored in the data storage means 101 (step B2). The weighting factor control means 108 sets the weighting factor candidate by which the first model and the second model are multiplied, to the predetermined initial value (step B3). Here, steps B1 to B3 may be in any processing order.

Next, the recognition means 105 recognizes the read data, by referencing to the first model, the second model, and the weighting factor candidate (step B4). The recognition means 105 stores the recognition result in the truth label storage means 102 as the truth label (step B5). In the case where the truth label is already stored in the truth label storage means 102, the recognition means 105 writes the new truth label over the stored truth label.

Note that the recognition means 105 may perform the processes of steps B2, B4, and BS by one operation. Moreover, in the case where the amount of data is relatively large, the recognition means 105 may employ pipeline processing of repeatedly executing a process of reading and recognizing the data in a small unit.

Next, the first model update means 106 adapts the first model to the target domain, based on the truth label stored in the truth label storage means 102. The first model update means 106 stores the updated first model obtained as a result of adaptation, in the first model storage means 103. Upon adaptation, the first model update means 106 may use the data stored in the data storage means 101 according to need.

Likewise, the second model update means 107 adapts the second model to the target domain, based on the truth label stored in the truth label storage means 102. The second model update means 107 stores the updated second model obtained as a result of adaptation, in the second model storage means 104. Upon adaptation, the second model update means 107 may use the data stored in the data storage means 101 according to need (step B6).

Next, the weighting factor control means 108 updates the weighting factor κ by which the first model and the second model are multiplied, according to, for example, the objective function exemplified in the above Expression 3 (step B7).

The weighting factor control means 108 then performs the convergence determination (step B8). In detail, in the case where the amount of change of the weighting factor κ is less than a predetermined threshold, the weighting factor control means 108 determines that the weighting factor κ has converged (“YES” in step B8), and ends the process. In the case where the amount of change of the weighting factor κ is less than the predetermined threshold, on the other hand, the weighting factor control means 108 determines that the weighting factor κ has not converged (“NO” in step B8), and repeats the process from step B4.

Note that the convergence determination method is not limited to the above-mentioned method. For example, the weighting factor control means 108 may determine whether or not the weighting factor κ has converged, by referencing to the model change, the truth label change, and the like. Moreover, the weighting factor control means 108 may set an upper limit to the number of times the weighting factor is updated, and end the process when the number of updates reaches the upper limit.

As described above, according to this exemplary embodiment, the recognition means 105 creates the truth label by recognizing the data of the target domain based on the first model, the second model, and the weighting factor candidate. The first model update means 106 updates the first model using the truth label, and the second model update means 107 updates the second model using the truth label. The weighting factor control means 108 controls the weighting factor when the recognition means 105 references to the first model and the second model.

In detail, the weighting factor control means 108 iteratively updates the weighting factor so as to assign a larger weight to a reliable model (i.e. a model having a smaller difference between the source domain and the target domain) among the first model and the second model. The recognition means 105 recognizes the data based on the weighting factor, and iteratively creates the truth label. The first model update means 106 and the second model update means 107 iteratively update the first model and the second model respectively, using the truth label created based on the weighting factor selected by the weighting factor control means 108.

According to the structure described above, in addition to the advantageous effects of Exemplary Embodiment 1, a favorable model can be created from the data of the target domain with a smaller amount of computation. That is, a favorable model can be created from the data of the target domain, by a smaller number of recognition processes than the number of weighting factor candidates in Exemplary Embodiment 1.

### Exemplary Embodiment 3

FIG. 5 is a block diagram showing an example of a model adaptation device in Exemplary Embodiment 3 of the present invention. The model adaptation device in this exemplary embodiment includes data storage means 701, truth label storage means 702, model storage means 72, recognition means 703, model update means 71, and weighting factor control means 704. The model storage means 72 includes first model storage means 721 to N-th model storage means 72N, where N is an integer not less than 3. The model update means 71 includes first model update means 711 to N-th model update means 71N.

The data storage means 701 stores the data of the target domain. The first model storage means 721 to the N-th model storage means 72N respectively store the first model to the N-th model used when recognizing the data.

The recognition means 703 recognizes the data by referencing to the first model to the N-th model. The truth label storage means 702 stores the recognition result output from the recognition means 105, as the truth label.

The first model update means 711 to the N-th model update means 71N respectively adapt the first model to the N-th model, using the data stored in the data storage means 701 and the truth label stored in the truth label storage means 702. The weighting factor control means 704 controls the weighting factor by which the first model to the N-th model are multiplied, when the recognition means 703 recognizes the data.

As mentioned above, the number of models which is two in Exemplary Embodiment 2 is extended to N (N>2) in Exemplary Embodiment 3 of the present invention. Various modes are conceivable for the recognition process of simultaneously handling more than two models. For example, a speech translation model corresponds to this. When translation is regarded as one type of recognition process for convenience's sake, a translation model for translating the recognition result is necessary in addition to the acoustic model and the language model used for speech recognition, in a system such as a speech translation system that recognizes speech and translates it to another language.

Moreover, in such a speech recognition system that uses a plurality of acoustic models and language models of different conditions in combination through a linear combination or the like, the use of the model adaptation device according to this exemplary embodiment enables the models used in the system to be adapted.

The recognition means 703, upon receiving the weighting factor from the weighting factor control means 704, reads the first model to the N-th model stored respectively in the first model storage means 721 to the N-th model storage means 72N according to need, and recognizes the data stored in the data storage means 701 based on these models and the weighting factor candidate. The recognition means 703 then stores the recognition result (i.e. truth label) in the truth label storage means 702. Note that, in the case where an old truth label is already stored in the truth label storage means 702, the recognition means 703 writes the new truth label over the old truth label.

The method of recognizing the data by the recognition means 703 is the same as the method described in Exemplary Embodiments 1 and 2. Moreover, it is desirable that the recognition result is the recognition result up to the N-th (N-best list) or in the form of a lattice (graph) or the like, as in Exemplary Embodiments 1 and 2.

It is also desirable that the recognition means 703 stores each intermediate recognition result obtained by recognition for each model during the process, in the truth label storage means 702. For example, in the case of performing speech translation mentioned above, the recognition means 703 stores each speech recognition result which is the intermediate recognition result in the truth label storage means 702 in addition to the final translation result.

The weighting factor control means 704 determines the weighting factor for each model. In this exemplary embodiment, the weighting factor control means 704 first performs an initialization process of setting the weighting factor candidate by which the first model to the N-th model are multiplied, to a predetermined initial value. In this exemplary embodiment, the weighting factor κ is not a scalar, but a vector having the number of dimensions obtained by subtracting 1 from the number of models, that is, (N−1) dimensions.

After the initialization process, the weighting factor control means 704 sequentially updates the weighting factor, by referencing to the recognition result (i.e. truth label) output from the recognition means 703 and stored in the truth label storage means 702, the data stored in the data storage means 701, and the first model to the N-th model respectively stored in the first model storage means 721 to the N-th model storage means 72N.

In the case where the recognition means 703 performs data recognition using the above Expression 1, the weighting factor control means 704 updates the weighting factor so as to maximize the conditional probability of the recognition result for the data of the target domain, as in Exemplary Embodiments 1 and 2. In detail, the weighting factor control means 704 updates the weighting factor so as to maximize the objective function exemplified in the above Expression 2. For example, the weighting factor control means 704 may update the weighting factor κ using the iterative solution method such as the steepest gradient algorithm exemplified in Exemplary Embodiment 2. Since the weighting factor κ is a vector as mentioned above, the update expression based on the steepest gradient algorithm can be represented by the following Expression 4.

$$\begin{matrix}[ Math . 4 ] & \\ {κ}_{i} ← {κ}_{i} + ρ \frac{\partial {P}_{κ} ( {W}^{( κ )} \vert O )}{\partial {κ}_{i}} & ( Expression 4 )\end{matrix}$$

Here, ρ is a predetermined constant indicating an update step size, and κᵢ is the i-th component of the vector κ (i=1, . . . , N−1).

The weighting factor control means 704 then performs convergence determination of determining whether or not to repeat updating the weighting factor based on a predetermined condition. The convergence determination method is the same as the method described in Exemplary Embodiment 2.

The first model update means 711 to the N-th model update means 71N respectively adapt the first model to the N-th model to the target domain, based on the latest recognition result (i.e. truth label) stored in the truth label storage means 702. The first model update means 106 may use the data stored in the data storage means 101 according to need. The first model update means 711 to the N-th model update means 71N respectively update the first model to the N-th model using the models obtained as a result of adaptation, and store the updated first model to N-th model in the first model storage means 721 to the N-th model storage means 72N respectively. The model adaptation method used here is the same as the model adaptation method of the first model update means 106 and the second model update means 107 in Exemplary Embodiment 1.

For example, the data storage means 701, the truth label storage means 702, and the model storage means 72 (more specifically, the first model storage means 721 to the N-th model storage means 72N) are realized by a magnetic disk or the like.

The recognition means 703, the model update means 71 (more specifically, the first model update means 711 to the N-th model update means 71N), and the weighting factor control means 704 are realized by a CPU of a computer operating according to a program (program for model adaptation).

The operation of the model adaptation device in this exemplary embodiment is the same as the operation of the model adaptation device in Exemplary Embodiment 2, and so its description is omitted. The model adaptation device in this exemplary embodiment is capable of handling arbitrary data such as speech, an image, and a video and the type of target data is not limited, as in Exemplary Embodiments 1 and 2.

As described above, according to this exemplary embodiment, the recognition means 703 creates the truth label by recognizing the data of the target domain based on the first model to the N-th model and the weighting factor candidate. The first model update means 711 to the N-th model update means 71N respectively update the first model to the N-th model using the truth label. The weighting factor control means 704 controls the weighting factor when the recognition means 703 references to the first model to the N-th model.

In detail, the weighting factor control means 704 iteratively updates the weighting factor so as to assign a larger weight to a reliable model (i.e. a model having a smaller difference between the source domain and the target domain) among the first model to the N-th model. The recognition means 703 recognizes the data based on the weighting factor, and iteratively creates the truth label. The first model update means 711 to the N-th model update means 71N iteratively update the first model to the N-th model respectively, using the created truth label.

According to the structure described above, in addition to the advantageous effects of Exemplary Embodiment 2, a favorable model can be created from the data of the target domain even in the case where an arbitrary number (N>2) of models are to be adapted to the target domain. In the case where the number N of models to be adapted is large, it is necessary to search a high-dimensional (N−1) space in order to obtain the optimal value of the weighting factor K. Though a large amount of computation is typically required for such search, in this embodiment the optimal value of the weighting factor κ can be obtained with a relatively small amount of computation because the search algorithm such as the steepest gradient algorithm is used.

FIG. 6 is a block diagram showing an example of a computer for realizing the model adaptation device in Exemplary Embodiment 1 or 2 of the present invention.

A storage device 83 includes data storage means 831, truth label storage means 832, first model storage means 833, and second model storage means 834. The data storage means 831, the truth label storage means 832, the first model storage means 833, and the second model storage means 834 respectively correspond to data storage means 101, truth label storage means 102, first model storage means 103, and second model storage means 104 in Exemplary Embodiment 1 or 2. Thus, the storage device 83 stores the recognition target data, the truth label, the first model, and the second model.

A program for model adaptation 81 according to the present invention is read by a data processing device 82 to control the operation of the data processing device 82.

Here, the data processing device 82 operates as the recognition means 105, the first model update means 106, the second model update means 107, and the weighting factor control means 108 in Exemplary Embodiment 1 or 2. In detail, the data processing device 82 performs a process of reading necessary information from the storage device 83 and a process of writing information such as a created model to the storage device 83.

The following describes a minimum structure of the present invention. FIG. 7 is a block diagram showing an example of a minimum structure of a model adaptation device according to the present invention. The model adaptation device according to the present invention includes:

recognition means 81 (e.g. the recognition means 105) for creating a recognition result of recognizing data that complies with a target domain which is an assumed condition of recognition target data, based on at least two models (e.g. the acoustic model and the language model) and a candidate of a weighting factor indicating a weight of each model on a recognition process; model update means 82 (e.g. the first model update means 106, the second model update means 107) for updating at least one model out of the models, using the recognition result as a truth label; and weighting factor determination means 83 (e.g. the weighting factor control means 108) for determining the weighting factor.

The weighting factor determination means 83 determines the weighting factor so as to assign a smaller weight to a model having higher reliability. The recognition means 81 creates the recognition result based on the weighting factor determined by the weighting factor determination means 83. The model update means 82 updates the model, using the recognition result created based on the weighting factor as the truth label.

According to such a structure, a favorable model can be created from the data of the target domain even in the case where there is a difference between the original domain and the target domain and a lot of noise representing recognition errors is contained in the truth label created based on the original domain.

Moreover, the weighting factor determination means 83 may determine the weighting factor (e.g. based on Expression 2) so as to maximize a conditional probability (e.g. the conditional probability P(W|O) of the recognition result W when the data O of the target domain is given) of the recognition result created by the recognition means, when the data of the target domain is given.

Moreover, the recognition means 81 may create the recognition result of the data of the target domain, for each of a plurality of candidates of the weighting factor, wherein the weighting factor determination means 83 determines the weighting factor by selecting, from the candidates of the weighting factor, a weighting factor (κ that maximizes the objective function of Expression 2) that maximizes a likelihood of the recognition result for the data of the target domain.

Moreover, the model update means 82 may update the model using, as the truth label, the recognition result created based on the models weighted by the weighting factor selected by the weighting factor determination means 83, wherein the recognition means 81 creates the recognition result again for each of the plurality of candidates of the weighting factor, based on the updated model, and wherein the weighting factor determination means 83 determines the weighting factor, by selecting the weighting factor again from the plurality of candidates of the weighting factor based on the created recognition result.

Moreover, the weighting factor determination means 83 may perform convergence determination of determining whether or not to repeat updating the weighting factor based on a predetermined condition (e.g. the difference between the weighting factor before update and the weighting factor after update is greater than a predetermined threshold), and update the weighting factor on a condition that the convergence determination results in determining to update the weighting factor, wherein the recognition means 81 updates the recognition result based on the models weighted by the updated weighting factor, on a condition that the convergence determination results in determining to update the weighting factor.

Moreover, the weighting factor determination means 83 may update, based on a steepest gradient algorithm, the weighting factor so as to maximize a conditional probability of the recognition result created by the recognition means 81, when the data of the target domain is given.

Moreover, the recognition means 81 may create the recognition result of recognizing the data that complies with the target domain, based on at least three models (e.g. N models) and the candidate of the weighting factor, wherein the model update means 82 updates at least one model out of the at least three models, using the recognition result as the truth label, and wherein the weighting factor determination means 83 determines the weighting factor so as to assign a smaller weight to a model having higher reliability out of the at least three models.

Moreover, the weighting factor determination means 83 may determine that a weighting factor of a model having a larger gap between an assumed condition of the model and the target domain is smaller.

Though the present invention has been described with reference to the exemplary embodiments and examples, the present invention is not limited to the above exemplary embodiments and examples. Various changes understandable by those skilled in the art within the scope of the present invention can be made to the structures and details of the present invention.

This application claims priority based on Japanese Patent Application No. 2011-021918 filed on Fe. 3, 2011, the disclosure of which is incorporated herein in its entirety.

### INDUSTRIAL APPLICABILITY

The present invention is preferably applied to a model adaptation device that performs model adaptation using data not assigned a truth label, namely, unsupervised adaptation. For example, the present invention is applied to a speech recognition device for inputting information to an appliance by speech input, a character recognition device for inputting information to an appliance by handwriting input, an optical character reader (OCR) for scanning a paper document to digitize it, and the like. The present invention is also applicable to a gesture recognition device for operating an appliance or the like by gesture, a video indexing device for detecting an event such as a home run scene in live baseball broadcast or a goal scene in succor and indexing it, and so on.

### REFERENCE SIGNS LIST

10, 72 model storage means
20, 71 model update means
101, 701, 831 data storage means
102, 202, 702, 832 truth label storage means
103, 721, 833 first model storage means
104, 722, 844 second model storage means
105, 703 recognition means
106, 711 first model update means
107, 712 second model update means
108, 704 weighting factor control means
201 speech data storage means
203 acoustic model storage means
204 language model storage means
205 speech recognition means
206 acoustic model update means
207 language model update means
71N N-th model update means
72N N-th model storage means
81 program for model adaptation
82 data processing device
83 storage device

1. A model adaptation device comprising:
a recognition unit for creating a recognition result of recognizing data that complies with a target domain which is an assumed condition of recognition target data, based on at least two models and a candidate of a weighting factor indicating a weight of each model on a recognition process;
a model update unit for updating at least one model out of the models, using the recognition result as a truth label; and
a weighting factor determination unit for determining the weighting factor,
wherein the weighting factor determination unit determines the weighting factor so as to assign a larger weight to a model having higher reliability,
wherein the recognition unit creates the recognition result based on the weighting factor determined by the weighting factor determination unit, and
wherein the model update unit updates the model, using the recognition result created based on the weighting factor as the truth label.

2. The model adaptation device according to claim 1, wherein the weighting factor determination unit determines the weighting factor so as to maximize a conditional probability of the recognition result created by the recognition unit, when the data of the target domain is given.

3. The model adaptation device according to claim 1, wherein the recognition unit creates the recognition result of the data of the target domain, for each of a plurality of candidates of the weighting factor, and
wherein the weighting factor determination unit determines the weighting factor by selecting, from the candidates of the weighting factor, a weighting factor that maximizes a likelihood of the recognition result for the data of the target domain.

4. The model adaptation device according to claim 3, wherein the model update unit updates the model using, as the truth label, the recognition result created based on the models weighted by the weighting factor selected by the weighting factor determination unit,
wherein the recognition unit creates the recognition result again for each of the plurality of candidates of the weighting factor, based on the updated model, and
wherein the weighting factor determination unit determines the weighting factor, by selecting the weighting factor again from the plurality of candidates of the weighting factor based on the created recognition result.

5. The model adaptation device according to claim 1, wherein the weighting factor determination unit performs convergence determination of determining whether or not to repeat updating the weighting factor based on a predetermined condition, and updates the weighting factor on a condition that the convergence determination results in determining to update the weighting factor, and
wherein the recognition unit updates the recognition result based on the models weighted by the updated weighting factor, on a condition that the convergence determination results in determining to update the weighting factor.

6. The model adaptation device according to claim 5, wherein the weighting factor determination unit updates, based on a steepest gradient algorithm, the weighting factor so as to maximize a conditional probability of the recognition result created by the recognition means unit, when the data of the target domain is given.

7. The model adaptation device according to claim 1, wherein the recognition unit creates the recognition result of recognizing the data that complies with the target domain, based on at least three models and the candidate of the weighting factor,
wherein the model update unit updates at least one model out of the at least three models, using the recognition result as the truth label, and
wherein the weighting factor determination unit determines the weighting factor so as to assign a larger weight to a model having higher reliability out of the at least three models.

8. The model adaptation device according to claim 1, wherein the weighting factor determination unit determines that a weighting factor of a model having a larger gap between an assumed condition of the model and the target domain is smaller.

9. A model adaptation method comprising:
creating a recognition result of recognizing data that complies with a target domain which is an assumed condition of recognition target data, based on at least two models and a candidate of a weighting factor indicating a weight of each model on a recognition process;
determining the weighting factor so as to assign a larger weight to a model having higher reliability;
creating the recognition result based on the determined weighting factor; and
updating at least one model out of the models, using the recognition result as the truth label.

10. A non-transitory computer readable information recording medium storing a program for model adaptation that, when executed by a processor, performs a method for:
creating a recognition result of recognizing data that complies with a target domain which is an assumed condition of recognition target data, based on at least two models and a candidate of a weighting factor indicating a weight of each model on a recognition process;
determining the weighting factor so as to assign a larger weight to a model having higher reliability;
creating the recognition result based on the determined weighting factor; and
updating at least one model out of the models, using the recognition result as a the truth label.
